(19) United States
(12) Patent Application Publication
(10) Pub. No.: US 2014/0204569 A1
(43) Pub. Date: Jul. 24, 2014

(54) Flashlight Holding Cradle with Adjustable Aim

(71) Applicant: Daniel Lee Banagas, Menifee, CA (US)

(72) Inventor: Daniel Lee Banagas, Menifee, CA (US)

(21) Appl. No.: 13/463,789

(22) Filed: May 3, 2012

Related U.S. Application Data
(60) Provisional application No. 61/482,131, filed on May 3, 2011.

(51) Int. Cl. F21V 19/02; F21V 21/096; F21V 21/08

(52) U.S. Cl. CPC F21V 19/02; F21V 21/0832; F21V 21/08; F21V 21/0965
USPC 362/191

(57) ABSTRACT

A flashlight holding cradle device and method of making it, in which a semi-circular sleeve forms a cradle to hold various sizes of conventional flashlights. The cradle sleeve is manufactured by method of mold injection. A metal, two-piece casting mold of the cradle sleeve is produced and then injected with plastic material. After the injected material is separated from the metal casting, the cradle sleeve's semi-circular shape is formed. Two parallel slots on each side of the cradle and a hole in the cradle base are also formed during the mold injection process. The cradle sleeve is then over-molded with rubber material which gives the cradle a non-slip durable surface texture. A hook and loop (Velcro™) type of tension strap is fastened to the rigid frame section that is formed between the two sets of parallel slots located on each side of the cradle. A flashlight or other apparatus is then placed into the cradle with the tension strap being pulled over the flashlight and inserted through one of the two slots on the other side of the cradle sleeve. After being inserted through the slot, the hook and loop tension strap is then pulled back over the flashlight a second time and fastened to itself at the location that the tension strap originated. A rubber band strap may also be substituted in place of the hook and loop type strap to be used to secure a flashlight inside the cradle sleeve. A flexible arm of variable length is mounted to the underside base of the cradle sleeve at the upper end, and mounted to a tripod type of stand device at the lower end. The flexible arm allows the flashlight holding cradle to be adjusted to shine light in any direction, up and down, and side to side.

### TECHNICAL FIELD

Certain embodiments of the present disclosure generally relate flashlight accessories and, more particularly, to a flashlight holding cradle with adjustable aim.

### BACKGROUND

This invention relates to an improved flashlight holder cradle especially designed for use around the home, in an automobile, for camping, or in any other instance where it may be desired to support and adjust the aim of a conventional flashlight. When holding a flashlight, the cradle can be aimed towards any desired work surface; being adjustable either up or down, or side to side as desired.

The objects of the invention are to provide an affordable adjustable holder cradle for a flashlight, wherein a flashlight placed inside the cradle is secured tightly with a tension strap or band. The tension strap band may also contain a modification consisting of a rubber coating placed on the strap section that comes into contact with the flashlight resting inside the cradle. The rubber coating on the strap provides a non-slip surface that holds the flashlight more tightly in place.

The cradle embodiment is a semi-circular sleeve coated with a rubber over-mold material and can be attached to any conventional style camera tripod or similar stand device.

The flashlight cradle is attached to a tripod type of stand by means of a flexible arm that is mounted to the bottom side of the cradle base and to the top section of a tripod. The flexible arm mounting method can either be by using a standard screw size for easy detachment of the arm and cradle, or by gluing method that is more permanent. The flexible arm is comprised of metal flexible wire that can easily bend and hold its shape.

The method of flashlight attachment to the cradle sleeve can also be modified by the use of a magnet being attached to a band that is secured around a flashlight. A second magnet is placed in the top side of the cradle base, in the area where the flashlight will rest. The magnetic connection of the two magnets will allow the flashlight to be held tightly in place, and also allow the flashlight to be easily removed for use in the hand when desired.

There is a special need for a flashlight holding cradle that can hold any conventional type of flashlight simply and securely. The user easily places an existing flashlight into the cradle that they have around the home, and then secure it tightly in place with the tension strap or band. There is no need to purchase an additional adjustable flashlight device contained as one unit. Unfortunately, other types of adjustable flashlights manufactured as one self-contained unit, are more expensive to purchase, inconvenient to use, and consist of many moving parts that are prone to breaking with extended use.

### SUMMARY OF THE DISCLOSURE

Certain embodiments provide a method for producing a flashlight holding cradle consisting of a cradle sleeve with slots, a mounting hole in the base, and an adjustable tension strap band.

Certain embodiments provide a method of adding a modification to the flashlight cradle and tension strap band. A magnetic strap band can be secured around a flashlight and placed onto another magnet located in the base of the cradle sleeve. The strap band may also contain a rubberized section that comes in contact with the flashlight to hold it securely in place.

### DESCRIPTION OF THE DRAWING

So that the manner in which the above recited features of the present disclosure can be understood in detail, a more particular description of the disclosure, briefly summarized above, may be had by reference to embodiments, some of which are illustrated in the appended drawing. It is to be noted, however, that the appended drawing illustrates only typical embodiments of this disclosure and are therefore not to be considered limiting of its scope, for the disclosure may admit to other equally effective embodiments.

FIG. 1 illustrates an example of a flashlight holding cradle, in accordance with certain embodiments of the present disclosure.

### DETAILED DESCRIPTION

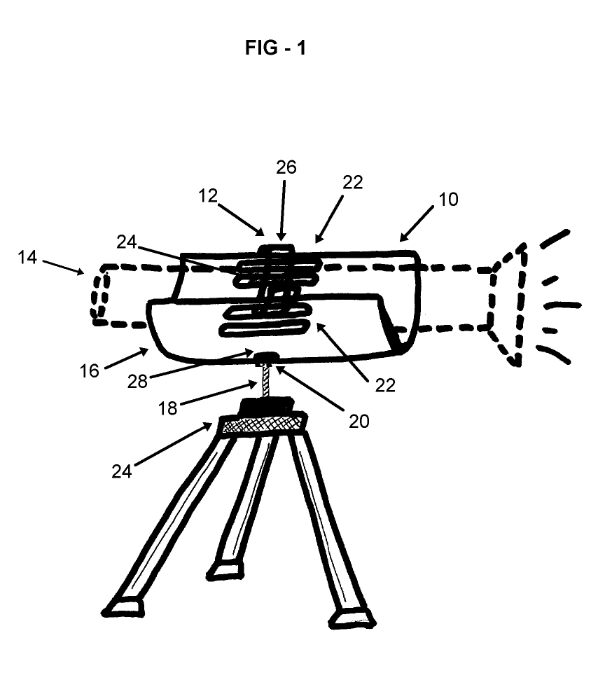

Referring to the drawing in FIG. 1 the flashlight holding cradle embodying the invention is designated generally at 10, a semi-circular cradle sleeve and comprised of a tension strap 12 and slots 22 to feed the tension strap through and provide leverage and tension to the flashlight 14 resting inside the cradle sleeve 10

By placing the slots 22 in specific locations, the tension strap 12 is secured at an angle that provides the proper amount of holding force to smaller diameter flashlights, without worry that smaller flashlights will fall out of the cradle when aiming the flashlight beam up or down at steep angles.

A rubber coating 16 is produced by over-molding method and molded around the entire cradle sleeve 10 providing a non-slip surface for the flashlight being placed inside.

A flexible wire arm 18 is secured to the underside center area of the cradle sleeve 20. The flexible arm allows the flashlight cradle to be adjusted and aims the flashlight beam either up and down or side to side, with the ability to remain in one position, shining light in one exact location.

A standard camera type of tripod 24 can be used as a stand for the flashlight cradle to be attached to. Depending on the length of the tripod legs, a flashlight placed in the cradle can be adjusted to a selected height as needed.

1. A method for aiming a flashlight and shining light on a specific surface, hands-free. A flashlight holding cradle comprised of a semi-circular sleeve having slots to attach a tension strap band and a mounting hole in the base of the cradle.

2. A method of claim #1 wherein the tension strap is comprised of hook and loop fastener strap.

3. The method of claim #1 wherein tension strap may be coated with rubber at the underside of the strap, at the area that will be in contact with the flashlight.

4. A method of claim #1 wherein the tension strap may be substituted with a rubber band to be used as a fastener to hold the flashlight secure inside the cradle sleeve.

5. A method of claim #1 wherein the tension strap band may contain a magnet attached to it for securing flashlight inside cradle sleeve

6. A method of claim #1 wherein the cradle sleeve may contain a magnet at the base

7. The method of claim #1 wherein the tension strap band provides adjustable tension by guiding it through the slots and wrapping it back around the cradle sleeve over the flashlight or other apparatus contained inside, and then fastened to itself securing the flashlight or other apparatus tightly.

8. The method of claim #1 wherein the flashlight holding cradle embodiment is coated with rubber to provide a non-slip surface and secure the flashlight contained inside the cradle sleeve.
